(19) United States
(12) Patent Application Publication
(10) Pub. No.: US 2026/0195637 A1
(43) Pub. Date: Jul. 9, 2026

(54) MULTIPLE HIERARCHICAL DIGITAL TWINS

(71) Applicant: International Business Machines Corporation, Armonk, NY (US)

(72) Inventors: Guang Han Sui, Beijing (CN); Peng Hui Jiang, Beijing (CN); Jun Su, Beijing (CN); Zhi Li Guan, Beijing (CN)

(21) Appl. No.: 19/011,116

(22) Filed: Jan. 6, 2025

(51) Int. Cl. G06N 20/00

(52) U.S. Cl. CPC G06N 20/00

(57) ABSTRACT

A method, according to one approach, includes: dividing a system into different levels in response to receiving a request to convert objects in the system into digital twins. The method also includes constructing digital twins of the objects in the respective system levels. Digital twins of objects in the same system level are assigned a same hierarchy value and digital twins of objects in different system levels are assigned different hierarchy values. Moreover, at least two of the digital twins of objects in a given system level are configured to perform a same operation, and at least two of the digital twins of objects in the given system level are configured to perform different operations. The method also includes directing operation requests intended for one or more of the objects to the respective digital twin(s), and the operation requests are performed by the respective digital twin(s).

### BACKGROUND

The present invention relates to digitalization, and more specifically, this invention relates to digital twins.

Data production continues to increase as computing power advances. For instance, the rise of smart enterprise endpoints has led to large amounts of data being generated at remote locations. Data production will only further increase with the growth of Internet of Things (IoT) devices and as the total number of devices that are connected to networks increases. As data production increases, so does the overhead associated with processing the larger amounts of data. Processing overhead is further increased when dealing with unstructured data and as different types of information are involved. For example, video and audio data may be combined in a pool of unstructured data, which results in longer processing times.

Artificial intelligence has been developed in an attempt to combat this rise in processing overhead. For instance, machine learning models may be used to inspect large amounts of data and draw inferences from patterns in the data. While this has reduced the amount of time that is spent analyzing data, advancements in artificial intelligence and sample sizes have also continued to increase, making data processing times and overhead a continued area of focus.

Conventional systems are thereby placed under high strain in order to satisfy increasing demand and it becomes increasingly difficult to use these systems effectively. For instance, the strain placed on logical and physical components in systems continues to intensify as data rates and throughput performance standards continue to increase. These components have thereby become a bottleneck.

### SUMMARY

A method, according to one approach, includes: dividing a system into two or more different levels in response to receiving a request to convert objects in the system into digital twins. The method also includes constructing digital twins of the objects in the respective levels of the system. Digital twins of objects in a same level of the system are assigned a same hierarchy value and digital twins of objects in different levels of the system are assigned different hierarchy values. Moreover, at least two of the digital twins of objects in a given level of the system are configured to perform a same operation, and at least two of the digital twins of objects in the given level of the system are configured to perform different operations. In response to receiving operation requests intended for one or more of the objects in the system, the method also includes directing the operation requests to the respective digital twin(s) of the one or more objects. Furthermore, the operation requests are performed by the respective digital twin(s).

A computer program product, according to another approach, includes: one or more computer readable storage media. The computer program product also includes program instructions that are stored on the one or more storage media to perform the foregoing method.

A computer system, according to yet another approach, includes: a processor set, and one or more computer readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of a method, in accordance with one approach.

FIG. 3C is a flowchart of a method, in accordance with one approach.

FIG. 4 is an overview of a process for converting objects in a system into digital twins, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for creating and managing multiple hierarchical digital twins for objects of a real-world system. Each digital twin supports (e.g., reflects) one or more different operations that are available to, or otherwise supported by, the respective object being represented. Moreover, the throughput of various objects in a system may be adjusted as desired to accommodate any workloads. This is accomplished by creating copies of digital twins to dynamically adjust the compute depth of each element. Accordingly, approaches herein are able to create an accurate and scalable digital representation of a desired system that replicates how the real-world system functions, which is capable of satisfying fluctuating demand without experiencing any bottlenecks, e.g., as will be described in further detail below.

In one general approach, a method includes: dividing a system into two or more different levels in response to receiving a request to convert objects in the system into digital twins. The method also includes constructing digital twins of the objects in the respective levels of the system. Digital twins of objects in a same level of the system are assigned a same hierarchy value and digital twins of objects in different levels of the system are assigned different hierarchy values. Moreover, at least two of the digital twins of objects in a given level of the system are configured to perform a same operation, and at least two of the digital twins of objects in the given level of the system are configured to perform different operations. In response to receiving operation requests intended for one or more of the objects in the system, the method also includes directing the operation requests to the respective digital twin(s) of the one or more objects. Furthermore, the operation requests are performed by the respective digital twin(s).

In another general approach, a computer program product includes: one or more computer readable storage media. The computer program product also includes program instructions that are stored on the one or more storage media to perform the foregoing method.

In yet another general approach, a computer system includes: a processor set, and one or more computer readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as new digital conversion code in block 150 for creating and managing multiple hierarchical digital twins for objects of a real-world system. Each digital twin supports (e.g., reflects) one or more different operations that are available to, or otherwise supported by, the respective object being represented. Moreover, the throughput of various objects in a system may be adjusted as desired to accommodate any workloads. This is accomplished by creating copies of digital twins to dynamically adjust the compute depth of each element. Accordingly, approaches herein are able to create an accurate and scalable digital representation of a desired system that replicates how the real-world system functions, which is capable of satisfying fluctuating demand without experiencing any bottlenecks, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

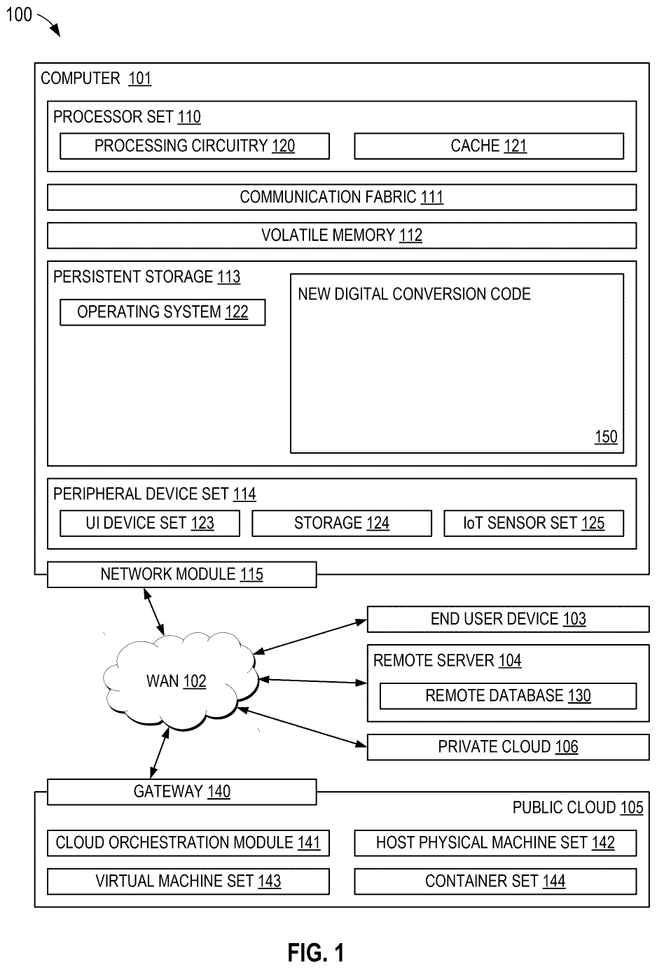

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase as computing power and the use of IoT devices advance. For instance, the rise of smart enterprise endpoints has led to large amounts of data being generated at remote locations. Data production will only further increase, and with it, the systems producing the data will continue to become more complex.

As data production process and the systems that produce the data increase in complexity, it becomes increasingly difficult to use these systems effectively. For instance, the strain placed on logical and physical components in systems continues to intensify as data rates and throughput performance standards continue to increase. These components have thereby become a bottleneck that prevents performance of the system as a whole from improving.

Approaches herein address this conventional shortcoming by developing digital twins of objects in a system such that the digital twins adhere to a hierarchical structure. The digital twins may thereby effectively function the same as the objects they represent and may be scaled as desired to represent different systems. Developing and maintaining a number of digital twins thereby allows for approaches herein to tailor (e.g., increase) system throughput to a desired level. Again, these digital twins are able to perform operations in parallel and/or according to a hierarchical order, allowing for the effective throughput of the system to be increased by dynamically adjusting the number of structured (e.g., according to a hierarchical or priority based order) digital twins that are active, e.g., as will be described in further detail below.

As used herein, a “digital twin” refers to any desired type of virtual representation of a logical and/or physical object that exists in a system, process, application, microservice, etc. A digital twin may thereby be configured to operate (e.g., react, produce outputs, satisfy requests, etc.) in a manner that mirrors how the corresponding logical and/or physical object is configured to operate. In other words, a digital twin will produce a same result as the actual object represented in response to any desired input (e.g., conditions). Said another way, a digital twin is a digital replica that acts as a counterpart to the logical and/or physical objects, mirroring the state of the objects, as well as allowing for testing and analysis to be performed without affecting the real-world objects.

Digital twins may thereby be used to create a visual representation of the physical assets or systems being simulated or monitored. Accordingly, digital twins may continuously receive data from the system (e.g., sensors positioned on a physical objects), allowing the digital twins to update their virtual representations in real-time. The digital twin can thereby be used to simulate different scenarios, predict potential issues, and test various design changes. Moreover, by implementing more than one copy of the same digital twin, approaches herein are desirably able to perform operations in parallel, e.g., as will be described in further detail below.

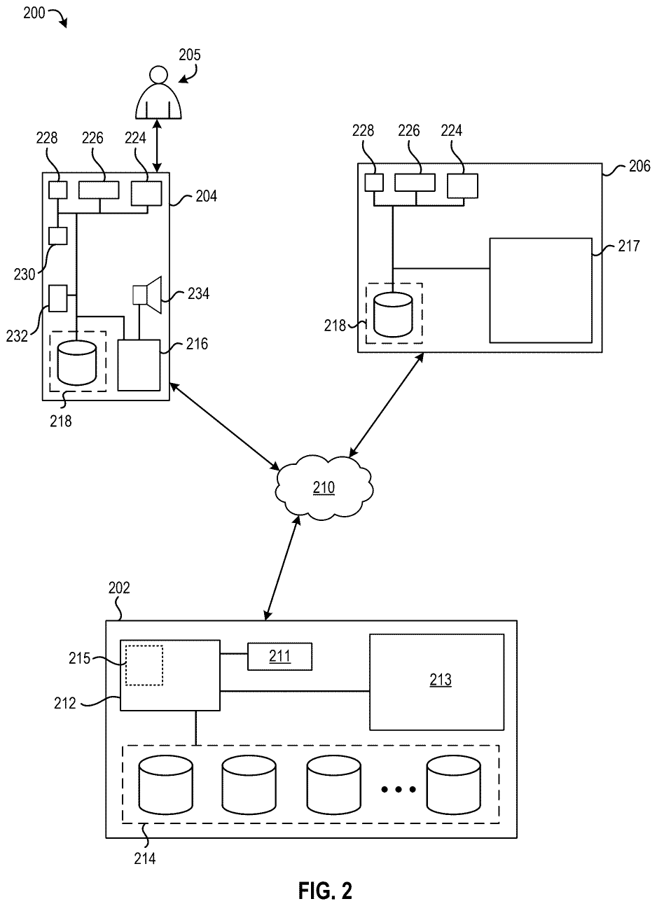

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204 accessible to the user 205, and a remote system 206. The central server 202, user device 204, and remote system 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, remote system 206, and/or central server 202, regardless of the amount of separation which exists therebetween, e.g., despite being positioned at different geographical locations.

However, it should be noted that two or more of the user device 204, remote system 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “client” are in no way intended to be limiting. For instance, while users and clients may be described as being individuals in various implementations herein, a user and/or client may be an application, an organization, a preset process, etc. The use of “data” and “information” herein is in no way intended to be limiting either, and may include any desired type of details, e.g., depending on the type of operating system implemented on the user device 204, remote system 206, and/or central server 202. For example, video data, audio data, sensor data, metadata, outputs produced by AI based models, images, etc. may be sent to the central server 202 from user device 204 and/or remote system 206 for processing using one or more AI based models, e.g., such as a foundation model and/or machine learning models.

With continued reference to FIG. 2, the central server 202 includes a large (e.g., robust) processor 212 coupled to a cache 211, an AI module 213, and a data storage array 214 having a relatively high storage capacity. As noted above, the AI module 213 may include any desired number and/or type of AI based models. In preferred approaches, the AI module 213 and/or processor 212 includes one or more AI based models that have been trained to evaluate the various details of a system, and convert objects in the system into digital twins that are configured to function (e.g., operate) the same as the respective objects they are imitating.

For example, the AI module 213 and/or processor 212 may include one or more AI based models that have been trained to evaluate the various details of remote system 206, identify the objects included therein, and convert the discovered objects into digital twins that are configured to function (e.g., operate) the same as the respective objects they are imitating. The AI based models may further be configured to monitor real-time performance of the system and the various objects therein, and update (e.g., retrain) the models to incorporate changes that occur as a result of the performance.

Similarly, in response to receiving updated information from a data source in response to one or more changes being made to the system and/or the objects therein, one or more AI based models may be recalibrated to incorporate the changes and maintain an accurate representation of the system and how the objects therein would react in a variety of given situations. For example, continually identifying changes in performance, supply data, settings, etc., of system levels and the objects therein allows for approaches herein to focus (e.g., improve) the data that is used to re-train AI based models used herein. In other words, the AI based models are continually recalibrated based on updated information provided by the data source and/or results produced in response by the digital twins (or objects themselves).

It follows that approaches herein use one or more AI based models to monitor the digital twins while performing the respective operation requests (i.e., performing the operations) and subsequently use details associated with performing the operation requests to re-train the AI based models. Moreover, the AI based models are trained to incorporate the relative hierarchy of the objects in the different system levels while evaluating the digital twins perform the operation requests and/or the results produced by the digital twins themselves, e.g., as will be described in further detail below.

The processor 212 also includes a redirection module 215 that is configured to evaluate received operation requests and redirect each of the requests to digital twins that are most desirably configured and/or situated to process the respective requests, and cause the requests to be satisfied. For example, the redirection module 215 may send a received operation request to one of the digital twin copies in a group that has a lowest workload in comparison to the remaining digital twin copies in the group. The digital twins may be stored in the processor 212 in some approaches. In other approaches, one or more of the digital twins are stored in the cache 211. In other approaches, one or more of the digital twins are stored in the data storage array 214. In some approaches, the redirection module 215 may send a received operation request to a digital twin that is configured to perform the specific type of operation that is requested.

With continued reference to FIG. 2, user device 204 includes a processor 216 which is coupled to memory 218. The user device 204 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using AI module 213. For instance, system log information may be received as a result of the user 205 using one or more applications, software programs, temporary communication connections, etc. running on the user device 204. For example, the user 205 may submit one or more data operation requests directed to the data storage array 214, and the data operations may be evaluated by the processor 212 and/or AI module 213 of central server 202 in response to being received. In other approaches, user 205 may use the user device 204 to enter a request to create digital twins (e.g., replicas) of the various objects identified in the remote system 206. In response to receiving the request, the central server 202 may submit requests to the remote system 206 for information associated with the objects included therein. Moreover, the central server 202 may divide the various objects identified therein into different hierarchical levels. In other words, the objects being converted into digital twins are separated into groups that are assigned different values that correspond to a hierarchical status of each object with respect to remaining objects in the system being digitally replicated. This allows for approaches herein to maintain and apply relative weights to the different digital twins formed that ensure each performs according to how the real-world objects would in the same circumstances, e.g., as would be appreciated by one skilled in the art after reading the present description. The hierarchical levels (e.g., values) may correspond to predetermined classifications of the different levels in a system and/or the objects included therein. For example, system levels involving “critical” resources (e.g., data encryption/decryption engines, network communication components, hardened memory, etc.) may be assigned a higher hierarchical value than system levels that include more reactionary objects (e.g., office furniture, physical locations, etc.). In some approaches, one or more AI based models may be configured to evaluate usage of the various objects in a system and divide them into hierarchical levels of differing weights based at least in part on relative usage levels, failures experienced, user input, etc. Moreover, outputs produced by objects (and corresponding digital twins) may be given different weight in making additional determinations. For example, data produced by objects may be assigned weights according to the hierarchy, and used to re-train one or more AI based models. In some approaches, objects identified as experiencing reoccurring failures may be removed from consideration during the re-training, thereby causing efficacy of the AI based models to improve over time.

Looking now to the remote system 206 of FIG. 2, the components included therein vary in number, type, configuration, arrangement, etc., depending on the desired approach. For instance, controller 217 is coupled to memory 218, a display screen 224, keys of a computer keyboard 226, and a computer mouse 228. While the remote system 206 is depicted as having a particular configuration with components therein, it should be noted that a system being represented by (e.g., converted into) digital twins may include any desired configuration. According to one example, an airport and the surrounding infrastructure may be designated as a “remote system” that is to be inspected and converted into digital twins. The digital twins may be scaled as desired, allowing for duplicates to be made of objects that are typically in high demand. This in turn allows for throughput of the system as a whole to increase by avoiding component based bottlenecks that would otherwise be experienced in the real-world system being evaluated and/or monitored. It follows that approaches herein are desirably able to improve performance of the system as a whole by selectively and dynamically tailoring the number of digital twins to any desired number and/or arrangement. For example, in some approaches one or more AI based models may be configured to monitor real-time performance of the various objects in a system and identify situations where throughput is strained or over broad. In situations of identified low throughput, the AI based models may be able to identify the one or more objects that are causing the bottleneck and automatically generate extra digital twins of the one or more objects, thereby alleviating the situation and improving system performance. Alternatively, in situations where actual (e.g., experienced) throughput is lower than the achievable throughput of one or more digital twins, the AI based models may automatically reduce the number of digital twins that exist, thereby freeing unused resources which may be reallocated to represent objects that are experiencing higher throughputs, e.g., as will be described in further detail below.

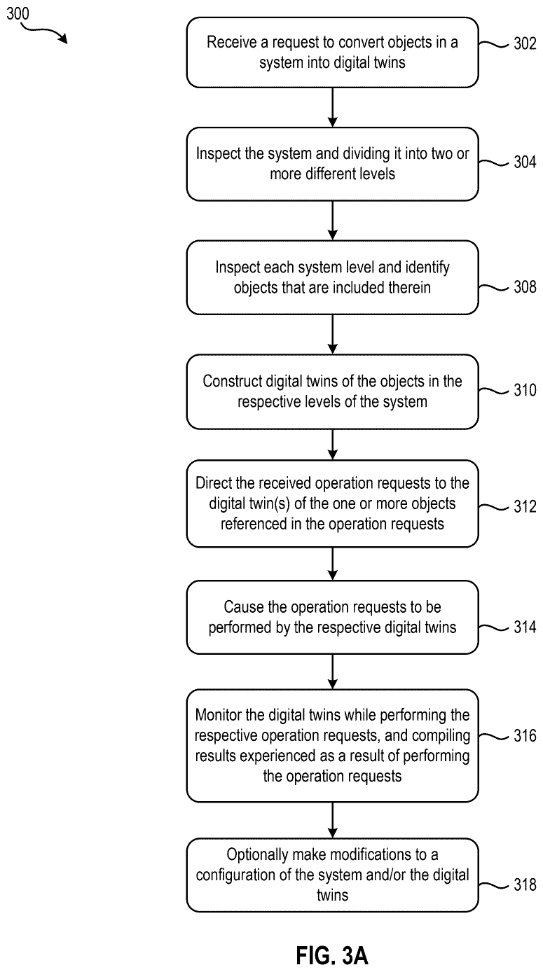

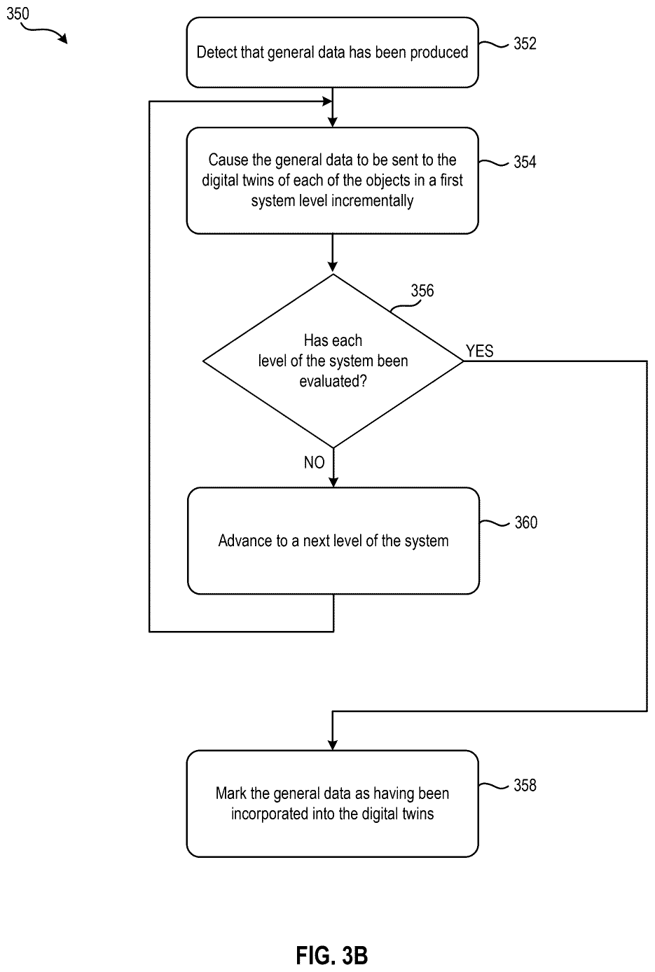

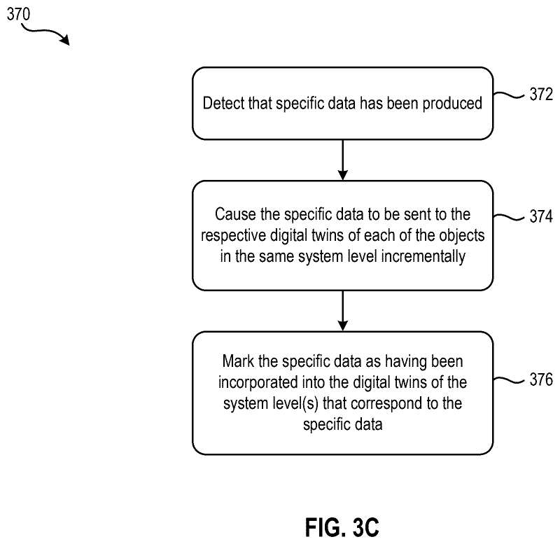

Looking now to FIG. 3A, a flowchart of a computer-implemented method 300 for creating and managing multiple hierarchical digital twins for objects of a real-world system is illustrated in accordance with one approach. Each digital twin supports (e.g., reflects) one or more different operations that are available to or otherwise supported by the respective object being represented. Accordingly, method 300 is able to create an accurate and scalable digital representation of a desired system that replicates how the real-world system functions. Method 300 may be performed in accordance with the present invention in any of the environments depicted in FIGS. 1-2, among others, in various approaches.

Of course, more or less operations than those specifically described in FIG. 3A may be included in method 300, as would be understood by one of skill in the art upon reading the present descriptions. Each of the steps of the method 300 may be performed by any suitable component of the operating environment using known techniques and/or techniques that would become readily apparent to one skilled in the art upon reading the present disclosure. In some approaches, one or more processors located at a central server of a distributed system (e.g., see processor 212 of FIG. 2 above) and/or an AI based module (e.g., see AI based module 213 of FIG. 2 above) may be used to perform one or more of the operations in method 300. In another approach, one or more processors located at an edge server and/or an AI based module therein may be used to perform one or more of the operations in method 300.

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Looking to FIG. 3A, a request to convert objects in a system into digital twins is received. See operation 302. In some approaches, the request is received from a user that wishes to create a digital representation of a given system. In other approaches, the request may be received from a running application, in response to an output produced by an AI based model, in response to performance of the system drifting out of a predetermined range, etc. For instance, in some approaches one or more AI based models are trained to monitor performance of various objects in a system and trigger a conversion of at least some of the objects into digital twins.

In response to receiving the request, method 300 advances from operation 302 to operation 304. There, operation 304 includes inspecting the system and dividing it into two or more different levels. Depending on the approach, the different levels may correspond to the system security policy, different types of real-world logical and/or physical components, past performance, user preferences, etc. Each system level that is formed is also assigned a different relative hierarchical value, thereby providing relative weights for the respective levels. These hierarchical values may be derived from the type of objects that are in each of the system levels, predetermined settings, past performance, anticipated workloads, outputs produced by AI based models, etc. Accordingly, the hierarchical value assigned to each of the system levels may provide context that can be used to derive a relative importance (e.g., weight) of the objects that are in the respective system levels, e.g., as will be described in further detail below.

From operation 304, method 300 advances to operation 308. There, operation 308 includes inspecting each system level and identifying objects that are included therein. In other words, operation 308 includes reviewing the contents of each system level that is formed in operation 304 and identifying any objects that are included in any of the levels. As used herein, an “object” may include any type of real-world logical and/or physical component that is configured to operate in the corresponding level of the system. For example, real-world objects that are in a system level may include logical and/or physical compute based components (e.g., processors, controllers, virtual machines, hypervisors, etc.) as well as non-compute based objects (e.g., mechanical systems, structures, resources, etc.), or any other elements that are identified in a given system. Objects may be identified by inspecting the system itself, reviewing summary information of the system, analyzing past performance and extrapolating the presence of certain objects, etc.

From operation 308, method 300 advances to operation 310. There, operation 310 includes constructing digital twins of the objects in the respective levels of the system. In other words, operation 310 includes creating a digital twin of each object in each level of the system. The digital twins are formed using various details that are collected from, or otherwise relate to, the objects that are identified in operation 304. For instance, information received from an object may be collected over time in a number of different scenarios and used to form an understanding of how that object operates (e.g., performs). That understanding may further be used to create a digital twin (or virtual representation) of the object that mirrors various details of the object and how it operates. The digital twin may thereby be able to perform a same one or more operations, produce a same one or more outputs, etc. as the object itself.

The accuracy of a digital twin may depend at least in part on the substance of the information that is available for a corresponding object. For example, objects having higher amounts of available details, e.g., such as performance history, manufacture dates, repairs, wear (e.g., use), certifications, etc. In some approaches, a digital twin may thereby step in and function as the source object by receiving and satisfying operations originally directed to the object. Adjusting (e.g., increasing) the number of digital twin copies for each object in a system further allows for achievable throughput to be tailored for each level of the system and/or the objects therein, e.g., based on anticipated workloads, current backlogs, past performance, predictions, etc.

For example, digital twins that are configured to perform the same operation(s) are representations of a same one of the objects in the given system level, while the digital twins that are configured to perform different operations are representations of different ones of the objects in the given system level. In other words, at least two of the digital twins of objects in a given level of the system are copies of a same object and thereby configured to perform a same operation. However, at least two of the digital twins of objects in the given level of the system are not copies of a same base object and thereby are configured to perform different operations. As noted above, a “digital twin” refers to any desired type of virtual representation of a logical and/or physical object that exists in a system, process, application, microservice, etc. A digital twin may thereby be configured to operate (e.g., react, produce outputs, satisfy requests, etc.) in a manner that mirrors how the corresponding logical and/or physical object is configured to operate without impacting or affecting the object itself.

The digital twins are preferably updated over time as new information about the objects is received, the new information replacing or supplementing existing information. The digital twins may thereby provide a current (e.g., real-time) digital representation of the respective objects. Additionally, the digital twins are assigned hierarchy values. In some approaches, each digital twin is assigned a same hierarchy value as the system level it is included in. In other words, the digital twins of objects in a same level of the system are assigned a same hierarchy value and digital twins of objects in different levels of the system are assigned different hierarchy values. This allows for the digital twins to implement (e.g., adhere to) the hierarchical structure that the objects themselves are subject to, in addition to mirroring the operational details of each object. In turn, the accuracy with which the digital twins are able to predict and imitate actual object and/or system performance is improved significantly.

With continued reference to FIG. 3A, method 300 advances from operation 310 to operation 312 in response to receiving one or more operation requests intended for one or more of the objects in the system. In other words, operation 312 is performed after at least one operation request directed to an object, for which one or more digital twins have been created and implemented, is received. There, operation 312 includes directing the received operation requests to the digital twin(s) of the one or more objects referenced in the operation requests. Moreover, operation 314 includes causing the operation requests to be performed by the respective digital twins.

In some approaches, operations 312 and/or 314 is/are performed by sending one or more instructions to a redirection module (e.g., see redirection module 215 of FIG. 2) that is configured to evaluate received operation requests and redirect each of the requests to digital twins that functionally replace the objects that the requests are directed to. Each operation request is preferably directed to a digital twin that is most desirably configured and/or situated to process it. In other words, an operation request intended for an object having multiple digital twin copies is preferably sent to one of the digital twin copies having a fastest response time, a lowest backlog, a shortest completion latency, etc. This further improves performance and ensures operation requests are satisfied efficiently regardless of workload intensity (e.g., by producing copies of digital twins) and without impacting the real-word objects and/or system at all.

From operation 314, method 300 advances to operation 316. There, operation 316 includes monitoring the digital twins while performing the respective operation requests received in operation 312, and compiling results experienced as a result of performing the operation requests. In other words, operation 316 includes collecting any information that is produced or otherwise output by the digital twins while and/or after performing the received operation requests. The information collected in operation 316 is used in some approaches to re-train AI based models that are configured to evaluate performance of systems. In some approaches, AI based models are trained to incorporate the relative hierarchy values of the objects in the different system levels while evaluating the corresponding digital twins perform the operation requests, as well as the results that are produced by the digital twins themselves.

In other approaches, the information collected from the digital twins in operation 316 is used to update one or more data sources. In other words, any results and/or information produced by the digital twins in response to performing the operation requests can be used to update a data source. Moreover, in response to the data source being updated, the results and/or information may be used to update other digital twins. For example, the specific results and/or information may be shared between digital twins in the same system level as the respective digital twin(s) that performed the operation requests (e.g., see FIG. 3B). The general results and/or information may also be shared between digital twins that are in different system levels having different hierarchy values (e.g., see FIG. 3C). This sharing of information between the digital twins allows for them to remain accurate and up-to-date without sacrificing network bandwidth to do so.

From operation 316, method 300 advances to operation 318 where modifications are optionally made to a logical and/or physical configuration of the system and/or the digital twins. These modifications may be based at least in part on information that is produced by the digital twins in response to performing the respective operation requests. For instance, metadata, projections, analysis results, data tags, pointers, etc. produced by the digital twins as a result of performing the respective operation requests may be used to identify flaws in the real-world system or the digital twins replicating it. Modifying the system and/or digital twins allows approaches herein to address these flaws, and maintain dynamic, scalable, and accurate representations of real-world objects and systems. Moreover, this is achieved without impacting the actual system that is modeled. This desirably reduces overhead on system resources, improves longevity of logical and physical components in a system, increases achievable throughput by implementing redundant digital twins (e.g., to perform different operations in parallel), etc.

It should be noted that the flowchart may return to operation 312 in response to additional operation requests being received. It follows that operations 312, 314, 316, and/or 318 may be performed any desired number of times. Accordingly, method 300 may return to operation 310 from operation 318. There, the digital twins may be updated to reflect any changes to the system and/or objects therein.

As noted above, data is preferably shared between the digital twins themselves in an incremental manner, e.g., rather than being sent in a batch (e.g., in parallel) over a network. This saves network bandwidth. However, there are different ways of ensuring that each digital twin receives different types of relevant information to remain updated and effective in making determinations. For example, in FIG. 3B operations of a method 350 for distributing general information across digital twins in each of the system levels are illustrated in accordance with one approach. It follows that one or more of these operations may be performed in combination with the operations of method 300 above in order to maintain accurate and updated digital twins without sacrificing network bandwidth. However, it should be noted that the operations of FIG. 3B are illustrated in accordance with one approach which is in no way intended to be limiting.

As shown, operation 352 involves detecting that general data has been produced. In other words, operation 352 detects that information which pertains to all digital twins (and the system as a whole) has been produced. Depending on the approach, the general data may be produced by a data source, the real-world system, one or more objects in the system, AI based models evaluating performance of the system, etc. Some approaches thereby include a data source producing general data that is relevant to the objects in each level of the system. It follows that as used herein, “general data” refers to data that provides context across the system as a whole, including a wide array of object configurations. In other words, general data may include any information that provides rich insight across each level of the system and/or across each object in each level.

From operation 352, method 350 advances to operation 354. There, operation 354 includes causing the general data to be sent to the digital twins of each of the objects in a first system level incrementally. In other words, operation 354 includes causing the general data to be sent to a first digital twin (having a corresponding first hierarchical value) of a first object in a first system level, before being sent to a second digital twin (also having the first hierarchical value) of a second object in the first system level, before being sent to a third digital twin (also having the first hierarchical value) of a third object in the first system level, etc., until the digital twin (also having the first hierarchical value) of a final object in the first system level has received the newly formed general data.

In some approaches, digital twins evaluate and use the received general data before permitting it to be sent to the digital twin of a next object in a current system level. For example, a processor running a digital twin may use received general data to re-train AI based models used in combination with the digital twin, update one or more settings of the digital twin itself, supplement a memory repository, etc. In other approaches, digital twins may simply make a local copy of received general data before sending it along to the digital twin of a next object in the system level. This reduces the amount of time associated with implementing updates to general (or specific) data across two or more digital twins. Accordingly, the way that general data is used by each of the digital twins during the process of performing operation 354 varies depending on the particular approach.

In response to the digital twins of each object assigned to a first level having received the general data, the method 350 advances from operation 354 to operation 356. There, operation 356 includes determining whether each level of the system has been evaluated. In other words, operation 356 includes determining whether a desired number (e.g., percentage) of the digital twins of the objects in each of the system levels have been updated. In preferred approaches, operation 356 determines whether the digital twins of all of the objects in each system level have received the general data and been updated.

In response to determining that each of the digital twins of the objects in each of the system levels have been updated, method 350 advances from operation 356 to operation 358. There, operation 358 includes marking the general data as having been incorporated into the digital twins. This may include marking a task in a queue as completed before proceeding to a next chunk of new general or specific data to update the digital twins with. However, returning to operation 356, method 350 advances to operation 360 in response to determining that digital twins of objects in at least one other system level (or a portion thereof) have not yet been updated. There, operation 360 includes advancing to a next system level, before returning to operation 354. Accordingly, the general data may be sent to the digital twins of each of the objects in a next system level incrementally. It follows that any one or more of the approaches described above may be repeated for the “next” system level.

It follows that the operations in FIG. 3B may be repeated until all digital twins of all objects in all system levels have been updated with the new general data. As a result, the approaches herein are able to significantly reduce network overhead by reducing the amount of strain that is involved with implementing general updates across the various objects and corresponding digital twins in the levels of a system. For instance, rather than sending the updates to each digital twin over one or more networks in batches (e.g., in parallel), approaches herein distribute the overhead associated with maintaining and updated an accurate representation of the system across the different digital twins, thereby avoiding any temporary and/or prolonged strain on the network(s) extending therebetween. System orchestration performed by overarching processors is also improved by continually adjusting the configuration of digital twins, e.g., based on performance experienced by the underlying objects in the system. For example, continually identifying changes in performance, supply data, settings, etc., of system levels and the objects therein allows for approaches herein to focus (e.g., improve) the data that is used to re-train AI based models used herein. In other words, the AI based models are continually recalibrated based on updated information provided by the data source and/or results produced by the digital twins (or underlying objects themselves).

Again, data is preferably shared between the digital twins themselves in an incremental manner, e.g., rather than being sent in a batch (e.g., in parallel) over a network. This saves network bandwidth. However, there are different ways of ensuring that each digital twin receives different types of relevant information to remain updated and effective in making determinations. For example, in FIG. 3C operations of a method 370 for distributing specific information across the digital twins in a same system level are illustrated in accordance with one approach. It follows that one or more of these operations may be performed in combination with the operations of method 300 above in order to maintain accurate and updated digital twins without sacrificing network bandwidth. However, it should be noted that the operations of FIG. 3C are illustrated in accordance with one approach which is in no way intended to be limiting.

As shown, operation 372 involves detecting that specific data has been produced. In other words, operation 372 detects that information which pertains to the digital twins of objects that are in a same system level has been produced. Depending on the approach, the specific data may be produced by a data source, the real-world system, one or more objects in the system, AI based models evaluating performance of the system, etc. Some approaches thereby include a data source producing specific data pertaining to digital twins of objects that are in a same system level. It follows that as used herein, “specific data” refers to data that only provides context across a set of the digital twins that represent fewer than all of the object configurations. In other words, specific data may include any information that provides rich insight into objects that are assigned to a same level of the system (and that have a same hierarchy value). For instance, specific data may provide useful (e.g., desirable) context across objects and the respective digital twins that correspond to a same system level. Objects and/or the digital twins thereof having a same hierarchical value are thereby able to extract insight (e.g., value) from the same specific data that is directed to the respective system level.

From operation 372, method 370 advances to operation 374. There, operation 374 includes causing the specific data to be sent to the respective digital twins of each of the objects in the same system level incrementally. In other words, operation 374 includes causing the specific data to be sent to a first digital twin of a first object in a system level that corresponds to the specific data, before being sent to a second digital twin of a second object in the same system level corresponding to the specific data, before being sent to a third digital twin of a third object in the same system level, etc., until the digital twin of a final object in the same system level corresponding to the specific data has received the newly formed specific data.

As noted above, digital twins may evaluate and use the received specific data before permitting it to be sent to the digital twin of a next object in the given system level. For example, a processor running a digital twin may use received specific data to re-train AI based models used in combination with the digital twin, update one or more settings of the digital twin itself, supplement a memory repository, etc. In other approaches, digital twins may simply make a local copy of received specific data before sending it along to the digital twin of a next object in the system level. This reduces the amount of time associated with implementing updates to specific (or general) data across two or more digital twins. Accordingly, the way that specific data is used by each of the digital twins during the process of performing operation 374 varies depending on the particular approach.

In response to the digital twins of each object assigned to a first level having received the specific data, the method 370 advances from operation 374 to operation 376. There, operation 376 includes marking the specific data as having been incorporated into the digital twins of the system level(s) that correspond to the specific data. This may include marking a task in a queue as completed before proceeding to a next chunk of new general or specific data to update the digital twins with.

Again, methods 300, 350, 370 are desirably able to construct and maintain multiple hierarchical digital twins for the objects of assets or systems. Each digital twin supports one or more operations that may be the same or different operations that are supported by remaining digital twins in the same or different hierarchical levels of the system that is represented. As noted above, the system is preferably divided into several different levels, and at each level, digital twins are constructed for the corresponding objects therein. Operation requests that are intended for objects in the system can thereby be directed to corresponding digital twins that are configured to evaluate and process the operation requests. Accordingly, in situations having multiple digital twins that support different operations, a redirection module may be used to redirect requests to a most desirable one of the corresponding digital twins, and cause the requests to be satisfied. For example, the redirection module may send a received operation request to a digital twin in a group of digital twin copies that has a workload that is most idle in comparison to the other digital twin copies, e.g., as described above. Approaches herein are thereby able to utilize the digital twins to support operations from many users in parallel with no impact on the actual system itself such that even basic compute products (e.g., a personal computer) are able to support (e.g., facilitate) the process of forming and maintaining accurate digital twins of real-world objects in systems.

In some approaches, the operations of method 300, 350, and/or 370 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to evaluate and/or satisfy received operation requests while enforcing a hierarchical based structure. Initial training may include reward feedback based on the different types of requests that are received. Reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300, 350, and/or 370 may be performed. In some further approaches, the AI model may be a neuromyotonic AI model that may improve performance of computer devices in a system that are modeled (e.g., replicated) by the digital twins and/or AI based models. The neuromyotonic AI model may be configured to itself make determinations described in operations herein. Weight values may, in some approaches, be used by the AI based models to collect and analyze information and/or feedback potentially received from the digital twins of the system objects. Such an AI model ensures that digital representations of various real-world elements are accurate and stable, where the scale of such analysis and determinations would not otherwise be feasible for a human to perform. This is because humans are not able to efficiently convert real-world logical and/or physical objects into digital form, where the digital representation is configured to operate the same way that the real-world objects do, and would otherwise incorporate processing delays and errors in the process of attempting to do so. Accordingly, management of operations described herein is not able to be achieved by human manual actions.

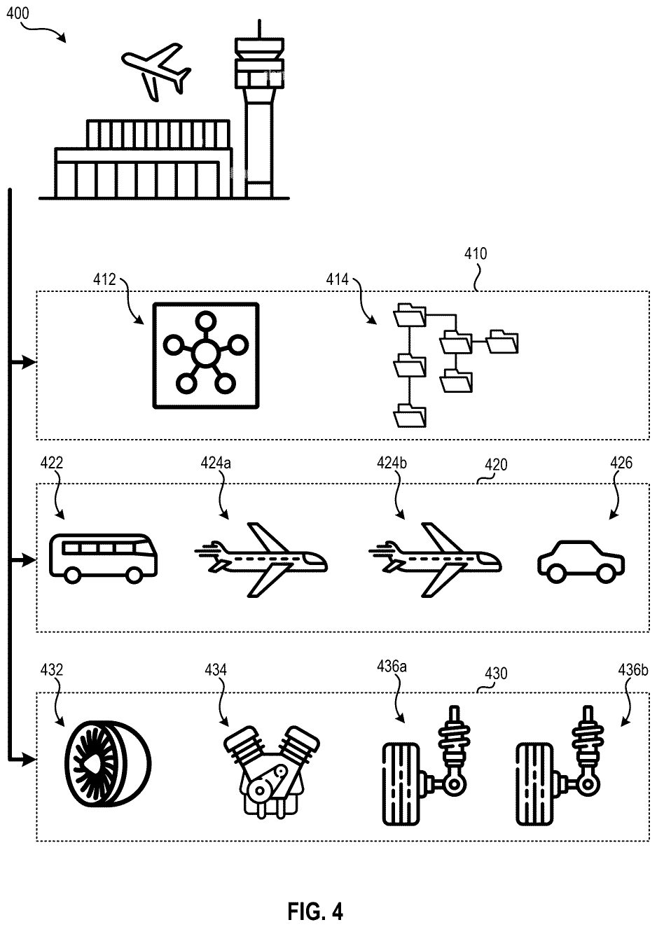

Looking now to FIG. 4, an overview of the process of converting the objects identified in an airport system 400 into digital twins is illustrated in accordance with an in-use example which is in no way intended to be limiting. Any of the operations included in the process of converting the airport system may incorporate any of the approaches described above and/or herein. The progression of FIG. 4 may be initiated in response to receiving an initial request to convert the airport system 400 into two or more different system levels.

In response to receiving the request, a processor preferably inspects the airport system 400 and identifies two or more levels therein. As shown, the airport system 400 is divided into three distinct levels 410, 420, 430, each of which include different objects therein which are in no way intended to be limiting. Level 410 includes objects that are associated with physical and/or logical structures identified in the airport system 400. Level 420 includes objects that are associated with vehicles identified in the airport system 400. Level 430 includes mechanical structures identified in the airport system 400.

The objects that are included in each of the system layers that are formed from the airport system 400 are further preferably converted into one or more digital twins of the real-world objects themselves. In other words, each of the objects identified in the system levels are preferably transformed into digital representations of the objects that provide detailed insight into how the various objects perform in a variety of different situations.

For instance, level 410 includes a digital twin 412 of the physical buildings located at the airport, as well as a digital twin 414 of the data that is located in memory at the airport system 400. Moreover, system level 420 includes a digital twin 422 of a bus, a digital twin of a car 426, as well as two digital twins 424a, 424b of an airplane. The two digital twins 424a, 424b may be mirrored copies of a same airplane in some approaches. As noted above, the number of copies of digital twins that exist may be adjusted dynamically to at least partially control the throughput of the digital twins themselves. Thus, by creating two digital twins 424a, 424b of a same airplane, the in-use example is able to reduce the latency associated with performing operation requests that involve the airplane, e.g., as would be appreciated by one skilled in the art after reading the present description.

Furthermore, system level 430 includes a digital twin 432 of a jet engine, a digital twin of an automobile engine 434, as well as two digital twins 436a, 436b of an automobile suspension system. As noted above, the two digital twins 436a, 436b may be mirrored copies of a same suspension system in some approaches. As noted above, the number of copies of digital twins that exist may be adjusted dynamically to at least partially control the throughput of the digital twins themselves. Thus, by creating two digital twins 436a, 436b of a same suspension system, the in-use example is able to reduce the latency associated with performing operation requests that involve the suspension system, e.g., as would be appreciated by one skilled in the art after reading the present description. Moreover, depending on the approach, different digital twins can run on different hosts (e.g., servers).

Again, approaches herein are desirably able to provide systems that are able to support multiple hierarchical based digital twins. Each digital twin may be configured to support the same and/or different operation(s) as other digital twins. In other words, the digital twins are each configured to perform or imitate one or more specific I/O commands that pertain to the overarching system and/or objects therein. Accordingly, different digital twins may be configured to evaluate different sources of information. At least some of the digital twins may also be initiated from a source (e.g., a user).

The digital twins are preferably configured such that information (e.g., data, sensor readings, details, metadata, etc.) can be easily and efficiently shared therebetween. In some approaches, the digital twins of objects in a same system level are configured to share information therebetween without using (e.g., relying on) the system's main network. According to one example, the digital twins can run on servers that are connected to a same dedicated LAN that allows for fast and efficient exchange of information between the digital twins. In another example, the digital twins can run on processors that are in a same server and connected by multiple electrically conductive physical connections that allow for fast and efficient exchange of information between the digital twins.

Moreover, received operation requests that are supported may be satisfied using the digital twins that are developed. For instance, operations received for certain objects may be directed to the corresponding digital twins. Approaches herein are again able to support hierarchical multiple digital twins an asset or system, where each digital twin further supports one or more operations. Operation requests may be directed to the corresponding digital twin(s) and satisfied without impacting the actual system. For each level of the hierarchy, some digital twins support different operations, while some digital twins support the same operations. Information may be shared between the digital twins differently depending on the configuration of the hierarchical structure and/or the type of information itself. Approaches are desirably able to implement hierarchical structures in order to achieve an effective digital representation of systems of varying size and scope.

Constructing and implementing hierarchical digital twins as discussed herein desirably saves network bandwidth and improves throughput of the system as a whole. Approaches herein are also able to balance workloads for complex systems and ensure that performance overall is improved. For instance, approaches involving the exchange of updated general data may send the general data to each digital twin incrementally. Similarly, data that is specific to a subset of digital twins may be sent to each digital twin in the subset incrementally. Approaches herein are thereby able to conserve network and compute bandwidth by exchanging updated data between the digital twins themselves. In still other approaches, updated data in a first digital twin may be used to synchronize (e.g., update) a data source, and subsequently update digital twins that are associated with (e.g., configured to perform a same operation as) the first digital twin.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
in response to receiving a request to convert objects in a system into digital twins, dividing the system into two or more different levels;
constructing digital twins of the objects in the respective levels of the system, wherein digital twins of objects in a same level of the system are assigned a same hierarchy value and digital twins of objects in different levels of the system are assigned different hierarchy values, wherein at least two of the digital twins of objects in a given level of the system are configured to perform a same operation, and at least two of the digital twins of objects in the given level of the system are configured to perform different operations;
in response to receiving operation requests intended for one or more of the objects in the system, directing the operation requests to the respective digital twin(s) of the one or more objects; and
causing the operation requests to be performed by the respective digital twin(s).

2. The method of claim 1, further comprising:
using results produced in response to the respective digital twin(s) performing the operation requests to update a data source; and
in response to the data source being updated, using the results to update digital twins in same system level(s) as the respective digital twin(s) that performed the operation requests.

3. The method of claim 1, further comprising:
in response to a data source producing general data pertaining to the system as a whole, causing the general data to be sent to the respective digital twins of the objects in a first system level incrementally; and
causing the general data to be sent to the respective digital twins of the objects in a second system level incrementally.

4. The method of claim 1, further comprising:
in response to a data source producing specific data pertaining to digital twins of objects in a same system level, causing the specific data to be sent to the respective digital twins of the objects in the same system level incrementally.

5. The method of claim 1, further comprising:
using results produced in response to the respective digital twin(s) performing the operation requests to re-train one or more AI based models, wherein the AI based models are configured to incorporate the hierarchy values of the objects in the different system levels while evaluating the operation requests and/or the results produced by the digital twins themselves.

6. The method of claim 1, further comprising:
make modifications to a configuration of the system and/or the digital twins based at least in part on information produced by the digital twins in response to performing the respective operation requests.

7. The method of claim 1, wherein the digital twins that are configured to perform the same operation are representations of a same one of the objects in the given system level, wherein the digital twins that are configured to perform different operations are representations of different ones of the objects in the given system level.

8. A computer program product comprising:
one or more computer readable storage media; and
program instructions stored on the one or more storage media to perform operations comprising:
in response to receiving a request to convert objects in a system into digital twins, dividing the system into two or more different levels;
constructing digital twins of the objects in the respective levels of the system, wherein digital twins of objects in a same level of the system are assigned a same hierarchy value and digital twins of objects in different levels of the system are assigned different hierarchy values, wherein at least two of the digital twins of objects in a given level of the system are configured to perform a same operation, and at least two of the digital twins of objects in the given level of the system are configured to perform different operations;
in response to receiving operation requests intended for one or more of the objects in the system, directing the operation requests to the respective digital twin(s) of the one or more objects; and
causing the operation requests to be performed by the respective digital twin(s).

9. The computer program product of claim 8, wherein the operations further comprise:
using results produced in response to the respective digital twin(s) performing the operation requests to update a data source; and
in response to the data source being updated, using the results to update digital twins in same system level(s) as the respective digital twin(s) that performed the operation requests.

10. The computer program product of claim 8, wherein the operations further comprise:
in response to a data source producing general data pertaining to the system as a whole, causing the general data to be sent to the respective digital twins of the objects in a first system level incrementally; and
causing the general data to be sent to the respective digital twins of the objects in a second system level incrementally.

11. The computer program product of claim 8, wherein the operations further comprise:
in response to a data source producing specific data pertaining to digital twins of objects in a same system level, causing the specific data to be sent to the respective digital twins of the objects in the same system level incrementally.

12. The computer program product of claim 8, wherein the operations further comprise:
using results produced in response to the respective digital twin(s) performing the operation requests to re-train one or more AI based models, wherein the AI based models are configured to incorporate the hierarchy values of the objects in the different system levels while evaluating the operation requests and/or the results produced by the digital twins themselves.

13. The computer program product of claim 8, wherein the operations further comprise:
make modifications to a configuration of the system and/or the digital twins based at least in part on information produced by the digital twins in response to performing the respective operation requests.

14. The computer program product of claim 8, wherein the digital twins that are configured to perform the same operation are representations of a same one of the objects in the given system level, wherein the digital twins that are configured to perform different operations are representations of different ones of the objects in the given system level.

15. A computer system comprising:
a processor set;
one or more computer readable storage media; and
program instructions stored on the one or more storage media to cause the processor set to perform operations comprising:
in response to receiving a request to convert objects in a system into digital twins, dividing the system into two or more different levels;
constructing digital twins of the objects in the respective levels of the system, wherein digital twins of objects in a same level of the system are assigned a same hierarchy value and digital twins of objects in different levels of the system are assigned different hierarchy values, wherein at least two of the digital twins of objects in a given level of the system are configured to perform a same operation, and at least two of the digital twins of objects in the given level of the system are configured to perform different operations;
in response to receiving operation requests intended for one or more of the objects in the system, directing the operation requests to the respective digital twin(s) of the one or more objects; and
causing the operation requests to be performed by the respective digital twin(s).

16. The computer system of claim 15, wherein the operations further comprise:
using results produced in response to the respective digital twin(s) performing the operation requests to update a data source; and
in response to the data source being updated, using the results to update digital twins in same system level(s) as the respective digital twin(s) that performed the operation requests.

17. The computer system of claim 15, wherein the operations further comprise:
in response to a data source producing general data pertaining to the system as a whole, causing the general data to be sent to the respective digital twins of the objects in a first system level incrementally; and
causing the general data to be sent to the respective digital twins of the objects in a second system level incrementally.

18. The computer system of claim 15, wherein the operations further comprise:
in response to a data source producing specific data pertaining to digital twins of objects in a same system level, causing the specific data to be sent to the respective digital twins of the objects in the same system level incrementally.

19. The computer system of claim 15, wherein the operations further comprise:
using results produced in response to the respective digital twin(s) performing the operation requests to re-train one or more AI based models, wherein the AI based models are configured to incorporate the hierarchy values of the objects in the different system levels while evaluating the operation requests and/or the results produced by the digital twins themselves.

20. The computer system of claim 15, wherein the operations further comprise:
make modifications to a configuration of the system and/or the digital twins based at least in part on information produced by the digital twins in response to performing the respective operation requests.
